(19) United States
(12) Patent Application Publication
(10) Pub. No.: US 2023/0119812 A1
(43) Pub. Date: Apr. 20, 2023

(54) HEAT TREATMENT OIL COMPOSITION

(71) Applicant: IDEMITSU KOSAN CO.,LTD., Chiyoda-ku (JP)

(72) Inventor: Takahito SUGIURA, Ichihara-shi (JP)

(73) Assignee: IDEMITSU KOSAN CO.,LTD., Chiyoda-ku (JP)

(21) Appl. No.: 17/759,873

(22) PCT Filed: Feb. 3, 2021
(86) PCT No.: PCT/JP2021/003929

§ 371 Date: Aug. 1, 2022

(30) Foreign Application Priority Data
Feb. 4, 2020 (JP) 2020-017125

(51) Int. Cl. C21D 1/58

(52) U.S. Cl. CPC C21D 1/58

(57) ABSTRACT

A quench oils composition containing a sulfur compound capable of improving the brightness of a metal material after a heat treatment, such as quenching, while preventing the sulfur content from being excessively increased. This is achieved by a quench oils composition containing one or more base oil selected from a mineral oil, a synthetic oil, and a vegetable oil, and one or more sulfur-containing aromatic compound selected from a particular sulfide compound and a particular sulfone compound.

### TECHNICAL FIELD

The present invention relates to a quench oils composition.

### BACKGROUND ART

Metal materials, such as a steel material, may be subjected to heat treatments, such as quenching, tempering, annealing, and normalizing, for the purpose of improving the properties thereof. In these heat treatments, quenching is a treatment of immersing a heated metal material into a cooling medium to transform into the prescribed hardened structure. The metal material becomes significantly hard through the quenching, and the mechanical strength thereof is enhanced.

A quench oils composition has been widely used as the cooling medium for quenching. The quench oils composition is demanded to have a capability as a cooling medium, and also a capability of retaining the surface glossiness of the metal material before quenching even after the quenching, from the standpoint of enhancing the market value of the metal material after quenching. Accordingly the quench oils composition is demanded to have a capability of improving the brightness of a metal material after quenching.

For example, PTL 1 proposes a quench oils composition containing a base oil obtained by blending at least one kind of a mineral oil and a synthetic oil each having a sulfur content of 300 ppm by mass or less and at least one kind of sulfur and a sulfur compound to regulate the total sulfur content to 3 ppm by mass to 1,000 ppm by mass, and at least one kind selected from the group consisting of an alkaline earth metal salt of sulfonic acid, an alkaline earth metal salt of phenol, an alkenylsuccinic acid derivative, a fatty acid, a fatty acid derivative, a phenol-based antioxidant, and an amine-based antioxidant. PTL 1 proposes that the brightness of the metal material after quenching is improved by the use of the quench oils composition.

### CITATION LIST

### Patent Literature

PTL 1: JP 7-070632 A

### SUMMARY OF INVENTION

### Technical Problem

It has been said that in general, the brightness of a metal material after quenching is lowered with the use of a quench oils composition having a small sulfur content. Accordingly it can be considered that the brightness of a metal material after quenching is improved by using a quench oils composition having a sulfur content that is increased by blending a sulfur compound.

On the other hand, an excessive increase of the sulfur content of the quench oils composition may cause formation of sludge. Furthermore, the lifetime of the quench oils composition itself may also be lowered thereby.

Therefore, a quench oils composition containing a sulfur compound that is capable of improving the brightness of a metal material after quenching while preventing the sulfur content of the quench oils composition from being excessively increased has been demanded. However, the investigations in this regard have not yet been sufficiently made. This demand also exists not only in the quench oils composition for quenching, but also in quench oils compositions for other heat treatments, such as tempering.

Under the circumstances, an object of the present invention is to provide a quench oils composition containing a sulfur compound that is capable of improving the brightness of a metal material after a heat treatment, such as quenching, while preventing the sulfur content thereof from being excessively increased.

### Solution to Problem

As a result of the earnest investigations by the present inventors, it has been found that the object can be achieved by a quench oils composition obtained by blending any one kind of a particular sulfide compound and a particular sulfone compound as a sulfur compound with a base oil, and thus the present invention has been completed.

The present invention relates to the following items [1] and [2].

[1] A quench oils composition containing

one or more kind of a base oil (A) selected from the group consisting of a mineral oil (A1), a synthetic oil (A2), and a vegetable oil (A3), and one or more kind of a sulfur-containing aromatic compound (B) selected from the group consisting of a sulfide compound (B1) represented by the following general formula (b1) and a sulfone compound (B2) represented by the following general formula (b2):

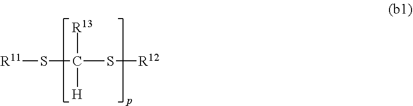

wherein in the general formula (b1), R¹¹, R¹², and R¹³ each independently represent a substituted or unsubstituted aryl group having 6 to 10 carbon atoms, and p represents 0 or 1,

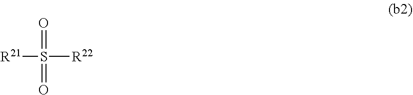

wherein in the general formula (b2), R²¹ and R²² each independently represent a substituted or unsubstituted aryl group having 6 to 10 carbon atoms.

[2] A method for producing a quench oils composition, including a step of mixing

one or more kind of a base oil (A) selected from the group consisting of a mineral oil (A1), a synthetic oil (A2), and a vegetable oil (A3), and

one or more kind of a sulfur-containing aromatic compound (B) selected from the group consisting of a sulfide compound (B1) represented by the following general formula (b1) and a sulfone compound (B2) represented by the following general formula (b2):

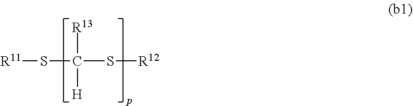

wherein in the general formula (b1), R¹¹, R¹², and R¹³ each independently represent a substituted or unsubstituted aryl group having 6 to 10 carbon atoms, and p represents 0 or 1,

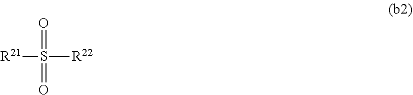

wherein in the general formula (b2), R²¹ and R²² each independently represent a substituted or unsubstituted aryl group having 6 to 10 carbon atoms.

### Advantageous Effects of Invention

According to the present invention, a quench oils composition containing a sulfur compound that is capable of improving the brightness of a metal material after a heat treatment, such as quenching, while preventing the sulfur content thereof from being excessively increased can be provided.

### BRIEF DESCRIPTION OF DRAWINGS

FIG. 1 is a diagram showing the positions of the “edge” and the “contact site” visually observed for the test piece used in the examples.

FIG. 2 is a drawing substitute photograph showing the state of the test pieces after the quenching test using the quench oils compositions of Examples 1 to 10.

FIG. 3 is a drawing substitute photograph showing the state of the test pieces after the quenching test using the quench oils compositions of Comparative Examples 1 to 5.

### DESCRIPTION OF EMBODIMENTS

In the description herein, the lower limit values and the upper limit values described in a stepwise manner for the preferred numerical ranges (such as the range of the content or the like) each may be independently combined. For example, from the description “preferably 10 to 90, and more preferably 30 to 60”, a range of “10 to 60” may be derived from the “preferred lower limit value (10)” and the “more preferred upper limit value (60)”.

In the description herein, the numerical range “lower limit value to upper limit value” means the lower limit value or more and the upper limit value or less unless otherwise indicated.

In the description herein, the numerical values in the examples can be used as the upper limit value and the lower limit value.

In the description herein, the “kinematic viscosity at 40° C.” may be referred simply to as a “40° C. kinematic viscosity”.

### Embodiments of Quench Oils Composition of Present Invention

The quench oils composition of the present invention is a quench oils composition containing one or more kind of a base oil (A) selected from the group consisting of a mineral oil (A1), a synthetic oil (A2), and a vegetable oil (A3), and one or more kind of a sulfur-containing aromatic compound (B) selected from the group consisting of a sulfide compound (B1) represented by the following general formula (b1) and a sulfone compound (B2) represented by the following general formula (b2):

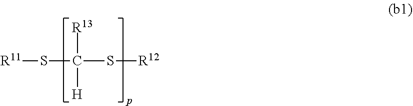

wherein in the general formula (b1), R¹¹, R¹², and R¹³ each independently represent a substituted or unsubstituted aryl group having 6 to 10 carbon atoms, and p represents 0 or 1,

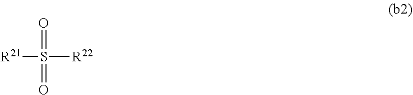

wherein in the general formula (b2), R²¹ and R²² each independently represent a substituted or unsubstituted aryl group having 6 to 10 carbon atoms.

The present inventors have made earnest investigations on sulfur compounds to be blended in a quench oils composition for improving the brightness of a metal material after a heat treatment, such as quenching. As a result, it has been found that a sulfide compound having an aryl group, such as a phenyl group, bonded to a sulfur atom and a sulfone compound having an aryl group, such as a phenyl group, bonded to a sulfur atom are significantly effective as a sulfur compound that improves the brightness of the metal material after a heat treatment, such as quenching. The present inventors have made further investigations based on the finding, and thus have completed the present invention.

In the following description, the “base oil (A)” and the “sulfur-containing aromatic compound (B)” may be referred to as a “component (A)” and a “component (B)”, respectively.

The mineral oil (A1), the synthetic oil (A2), and the vegetable oil (A3) may be referred to as a “component (A1)”, a “component (A2)”, and a “component (A3)”, respectively.

The sulfide compound (B1) represented by the general formula (b1) and the sulfone compound (B2) represented by the general formula (b2) may be referred to as a “component (B1)” and a “component (B2)”, respectively.

The quench oils composition of one embodiment of the present invention may be formed only of the component (A) and the component (B), and may contain an additional component other than the component (A) and the component (B) in such a range that does not impair the effects of the present invention.

In the quench oils composition of one embodiment of the present invention, the total content of the component (A) and the component (B) is preferably 75% by mass to 100% by mass, more preferably 80% by mass to 100% by mass, and further preferably 85% by mass to 100% by mass, based on the total amount of the quench oils composition.

The components contained in the quench oils composition of the present invention will be described in detail below.

### <Base Oil (A)>

The quench oils composition of the present invention contains a base oil (A). The base oil (A) is one or more kind selected from the group consisting of a mineral oil (A1), a synthetic oil (A2), and a vegetable oil (A3). The mineral oil (A1), the synthetic oil (A2), and the vegetable oil (A3) will be described in detail below.

### (Mineral Oil (A1))

The mineral oil (A1) used may be a mineral oil that has been generally used in a quench oils composition, with no particular limitation.

Specific examples of the mineral oil (A1) include an atmospheric residual oil obtained by subjecting a crude oil, such as a paraffin base crude oil, an intermediate base crude oil, and a naphthene base crude oil, to atmospheric distillation; a distillate oil obtained by subjecting the atmospheric residual oil to distillation under reduced pressure; a mineral oil obtained by subjecting the distillate oil to one or more treatment of solvent deasphalting, solvent extraction, hydrocracking, solvent dewaxing, catalytic dewaxing, hydro-refining, and the like; and a wax isomerization mineral oil.

The mineral oil (A1) may be a highly refined mineral oil (A1-1) having a reduced sulfur content obtained by performing a refining treatment including at least one kind of hydrocracking and hydro-refining.

The sulfur content of the highly refined mineral oil (A1-1) is preferably less than 10 ppm by mass, more preferably less than 5 ppm by mass, and further preferably less than 3 ppm by mass, based on the total amount of the highly refined mineral oil (A1-1).

The mineral oil (A1) may also be a bright stock (A1-2).

In the description herein, the “bright stock” means a high viscosity mineral oil obtained in such a manner that an atmospheric residual oil obtained by subjecting a crude oil, such as a paraffin base crude oil, an intermediate base crude oil, and a naphthene base crude oil, to atmospheric distillation is subjected to distillation under reduced pressure to provide a distillate oil, the distillate oil is then subjected to deasphalting to provide a deasphalted oil, and the deasphalted oil is subjected to one or more kind of a refining treatment selected from solvent refining, hydro-refining, and the like.

The sulfur content of the bright stock (A1-2) may be, for example, 0.30% by mass to 2.0% by mass, based on the total amount of the bright stock (A1-2).

The bright stock (A1-2) is preferably one classified into the Group I in the base oil category of American Petroleum Institute (API).

A mineral oil containing a bright stock having a large sulfur content may have been blended in a quench oils composition from the standpoint of improving the brightness of a metal material after a heat treatment, such as quenching, by increasing the sulfur content. However, as a result of the investigations by the present inventors, it has been found that the brightness of a metal material after a heat treatment, such as quenching, may be decreased in some cases with a quench oils composition having a mineral oil containing a bright stock having a large sulfur content blended therein, and in particular, the brightness of a metal material after a heat treatment, such as quenching, is readily decreased in the case where the heat treatment temperature is a high temperature of 900° C. or more (particularly 950° C. or more).

According to the investigations by the present inventors, it has been confirmed that even in the case where the mineral oil (A1) containing the bright stock (A1-2) is used as the base oil (A) contained in the quench oils composition, the brightness of a metal material after a heat treatment, such as quenching, can be improved by blending the sulfur-containing aromatic compound (B).

In the quench oils composition of one embodiment of the present invention, the bright stock (A1-2) is preferably used by blending in the base oil (A) corresponding to the desired viscosity and the desired sulfur content required for the quench oils composition.

In the case where the base oil (A) contains the bright stock (A1-2), the content of the bright stock (A1-2) is preferably 1% by mass or more, more preferably 2% by mass or more, and further preferably 3% by mass or more, and is preferably 20% by mass or less, more preferably 15% by mass or less, and further preferably 10% by mass or less, based on the total amount of the base oil (A).

The upper limit values and the lower limit values of these numerical ranges may be optionally combined. Specifically, the content thereof is preferably 1% by mass to 20% by mass, more preferably 2% by mass to 15% by mass, and further preferably 3% by mass to 10% by mass.

### (Synthetic Oil (A2))

The synthetic oil (A2) used may be a synthetic oil that has been generally used in a quench oils composition, with no particular limitation.

Specific examples of the synthetic oil (A2) include a poly-α-olefin compound, a polyphenyl ether, an alkylbenzene, an alkylnaphthalene, a polyphenyl-based hydrocarbon, an ester oil (for example, a fatty acid ester of a polyhydric alcohol, such as neopentyl glycol, trimethylolpropane, and pentaerythritol), a glycol-based synthetic oil, and a GTL base oil obtained by isomerizing wax produced from natural gas by the Fischer-Tropsch process or the like (GTL wax (gas-to-liquids wax)).

Among these, a GTL base oil is preferred.

The synthetic oil (A2) may be used alone or as a combination of two or more kinds thereof.

### (Vegetable Oil (A3))

The vegetable oil (A3) used may be a vegetable oil that has been generally used in a quench oils composition, with no particular limitation.

Specific examples of the vegetable oil (A3) include a linseed oil, a safflower oil, a sunflower oil, a soybean oil, a corn oil, a cotton seed oil, a sesame seed oil, an olive oil, a castor oil, a peanut oil, a coconut palm oil, a palm kernel oil, a palm oil, a coconut oil, a canola oil, and a rice bran oil.

The vegetable oil (A3) may be used alone or as a combination of two or more kinds thereof.

### (Preferred Embodiments of Base Oil (A))

In the quench oils composition of one embodiment of the present invention, the base oil (A) may be one or more kind selected from the group consisting of the mineral oil (A1), the synthetic oil (A2), and the vegetable oil (A3), and is preferably one or more kind selected from the group consisting of the mineral oil (A1) and the synthetic oil (A2).

The base oil (A) is more preferably formed only of the mineral oil (A1) or formed only of the synthetic oil (A2).

### (40° C. Kinematic Viscosity of Base Oil (A))

The 40° C. kinematic viscosity of the base oil (A) used in one embodiment of the present invention is preferably 5 mm²/s to 600 mm²/s, more preferably 6 mm²/s to 570 mm²/s, further preferably 7 mm²/s to 540 mm²/s, still further preferably 8 mm²/s to 520 mm²/s, and still more further preferably 9 mm²/s to 500 mm²/s.

In the case where the 40° C. kinematic viscosity of the base oil (A) is 5 mm²/s or more, a high flash point can be readily retained, and a quench oils composition with suppressed oil smoke can be readily obtained. In the case where the 40° C. kinematic viscosity of the base oil (A) is 600 mm²/s or less, a quench oils composition having a good cooling capability can be readily obtained.

In the description herein, the 40° C. kinematic viscosity is a value that is measured according to JIS K2283:2000.

The quench oils composition of one embodiment of the present invention preferably contains multiple kinds of base oils different in 40° C. kinematic viscosity mixed with each other in consideration of the facilitation of regulation of the 40° C. kinematic viscosity of the base oil (A).

### (Content of Base Oil (A))

In the quench oils composition of one embodiment of the present invention, the content of the base oil (A) is preferably 80.0% by mass or more, more preferably 82.0% by mass or more, and further preferably 83.0% by mass or more, and is preferably 99.98% by mass or less, based on the total amount of the quench oils composition.

### <Sulfur-containing Aromatic Compound (B)>

The quench oils composition of the present invention contains a sulfur-containing aromatic compound (B).

In the case where the quench oils composition does not contain the sulfur-containing aromatic compound (B), the brightness of a metal material after a heat treatment, such as quenching, cannot be improved.

The sulfur-containing aromatic compound (B) is one or more kind selected from the group consisting of a sulfide compound (B1) and a sulfone compound (B2).

The sulfide compound (B1) and the sulfone compound (B2) will be described in detail below.

In the description for the sulfur-containing aromatic compound (B), in the expression “substituted or unsubstituted X group having a to b carbon atoms”, the “a to b carbon atoms” means the number of carbon atoms in the case where the X group is unsubstituted, and does not include the number of carbon atoms of the substituent in the case where the X group is substituted.

### (Sulfide Compound (B1))

The sulfide compound (B1) is a sulfide compound represented by the following general formula (b1).

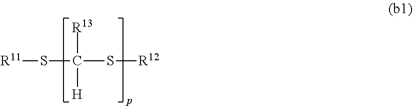

In the general formula (b1), R¹¹, R¹², and R¹³ each independently represent a substituted or unsubstituted aryl group having 6 to 10 carbon atoms, and p represents 0 or 1.

In the case where the aryl group having 6 to 10 carbon atoms has a substituent, the substituent is an aliphatic hydrocarbon group having 1 to 10 carbon atoms, an alkoxy group having 1 to 10 carbon atoms, a hydroxy group, an amino group, a nitro group, a sulfhydryl group, or a halogen atom (such as a fluorine atom, a chlorine atom, a bromine atom, or an iodine atom, and preferably a chlorine atom).

The sulfide compound (B1) may be used alone or as a combination of two or more kinds thereof.

Examples of the substituted or unsubstituted aryl group having 6 to 10 carbon atoms selected as R¹¹, R¹², and R¹³ include a substituted or unsubstituted phenyl group and a naphthyl group, and among these, a substituted or unsubstituted phenyl group is preferred.

The substituted or unsubstituted phenyl group is preferably a phenyl group represented by the following general formula (b·x).

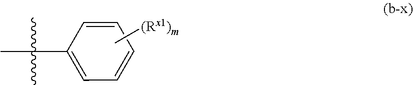

In the general formula (b·x), R^{x1} represents an aliphatic hydrocarbon group having 1 to 10 carbon atoms, an alkoxy group having 1 to 10 carbon atoms, a hydroxy group, an amino group, a nitro group, a sulfhydryl group, or a halogen atom (such as a fluorine atom, a chlorine atom, a bromine atom, or an iodine atom, and preferably a chlorine atom).

In the general formula (b·x), the wavy line shows the bonding site to the sulfur atom (for R¹¹ and R¹²) or the bonding site to the carbon atoms (for R¹³).

Examples of the aliphatic hydrocarbon group having 1 to 10 carbon atoms selected as R^{x1} include an alkyl group, such as a methyl group, an ethyl group, a propyl group, a butyl group, a pentyl group, and a hexyl group; and an alkenyl group, such as an ethenyl group, a propenyl group, a butenyl group, a pentenyl group, and a hexenyl group. The alkyl group and the alkenyl group each may be linear or branched. Specifically in the case where the aliphatic hydrocarbon group having 1 to 10 carbon atoms as the substituent is a butyl group, the butyl group may be any of a n-butyl group, an isobutyl group, a sec-butyl group, and a tert-butyl group.

Examples of the hydrocarbon group constituting the alkoxy group having 1 to 10 carbon atoms selected as R^{x1} include the same groups as for the aliphatic hydrocarbon group having 1 to 10 carbon atoms as the substituent.

In the general formula (b·x), m represents an integer of 0 to 5. m preferably represents 0 to 4, and more preferably 0 to 3. In the case where m is 2 or more, plural groups represented by R^{x1} may be the same as or different from each other.

In the general formula (b·x), m=0 is preferred.

In the case where m is 1 in the general formula (b·x), R^{x1} preferably represents an aliphatic hydrocarbon group having 1 to 10 carbon atoms or a hydroxy group. The aliphatic hydrocarbon group having 1 to 10 carbon atoms selected as R^{x1} is preferably an aliphatic hydrocarbon group having 1 to 4 carbon atoms, and more preferably a methyl group or a tert-butyl group.

In the case where m is 2 or more in the general formula (b·x), plural groups represented by R^{x1} each are preferably selected from an aliphatic hydrocarbon group having 1 to 10 carbon atoms and a hydroxy group. The plural groups represented by R^{x1} may be the same as or different from each other, and are preferably a combination of an aliphatic hydrocarbon group having 1 to 10 carbon atoms and a hydroxy group. The aliphatic hydrocarbon group having 1 to 10 carbon atoms selected as R^{x1} is preferably an aliphatic hydrocarbon group having 1 to 4 carbon atoms, and more preferably a methyl group or a tert-butyl group. In a further preferred embodiment, m is 3, and three groups represented by R^{x1} are a methyl group, a tert-butyl group, and a hydroxy group.

Preferred examples of the substituted or unsubstituted phenyl group represented by the general formula (b·x) include a phenyl group, a tert-butylphenyl group, and a 6-tert-butyl-m-cresyl group.

In the general formula (b1), p represents 0 or 1, and p is preferably 0 from the standpoint of facilitating the effects of the present invention.

Specific examples of the sulfide compound (B1) include diphenyl sulfide, phenylbis(phenylthio)methane, 4-tert-butyldiphenyl sulfide, and 4,4′-thiobis(6-tert-butyl-m-cresol). Among these, diphenyl sulfide, 4-tert-butyldiphenyl sulfide, and 4,4′-thiobis(6-tert-butyl-m-cresol) are preferred, and diphenyl sulfide and 4,4′-thiobis(6-tert-butyl-m-cresol) are more preferred.

### (Sulfone Compound (B2))

The sulfone compound (B2) is a sulfone compound represented by the following general formula (b2).

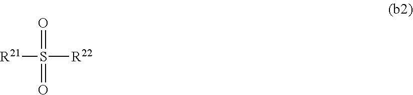

In the general formula (b2), R²¹ and R²² each independently represent a substituted or unsubstituted aryl group having 6 to 10 carbon atoms.

In the case where the aryl group having 6 to 10 carbon atoms has a substituent, the substituent is an aliphatic hydrocarbon group having 1 to 10 carbon atoms, an alkoxy group having 1 to 10 carbon atoms, a hydroxy group, an amino group, a nitro group, a sulfhydryl group, or a halogen atom (such as a fluorine atom, a chlorine atom, a bromine atom, or an iodine atom, and preferably a chlorine atom).

The sulfone compound (B2) may be used alone or as a combination of two or more kinds thereof.

Examples of the substituted or unsubstituted aryl group having 6 to 10 carbon atoms selected as R²¹ and R²² include a substituted or unsubstituted phenyl group and a naphthyl group, and among these, a substituted or unsubstituted phenyl group is preferred.

Examples of the substituted or unsubstituted phenyl group include a phenyl group represented by the general formula (b·x), and the preferred embodiments thereof have been described above.

Preferred specific examples of the sulfone compound (B2) include diphenyl sulfone.

### (Content of Sulfur-containing Aromatic Compound (B))

In the quench oils composition of one embodiment of the present invention, the content of the sulfur-containing aromatic compound (B) is preferably 0.02% by mass or more, more preferably 0.05% by mass or more, further preferably 0.08% by mass or more, and still further preferably 0.10% by mass or more, and is preferably 5.5% by mass or less, more preferably 5.0% by mass or less, further preferably 4.5% by mass or less, and still further preferably 4.0% by mass or less, based on the total amount of the quench oils composition, from the standpoint of facilitating the effects of the present invention and the standpoint of suppressing the formation of sludge and the decrease of the lifetime of the quench oils composition due to the excessive use of the sulfur compound.

The upper limit values and the lower limit values of these numerical ranges may be optionally combined. Specifically the content thereof is preferably 0.02% by mass to 5.5% by mass, more preferably 0.05% by mass to 5.0% by mass, further preferably 0.08% by mass to 4.5% by mass, and still further preferably 0.10% by mass to 4.0% by mass.

### (Molecular Weight of Sulfur-containing Aromatic Compound (B))

In the quench oils composition of one embodiment of the present invention, the molecular weight of the sulfur-containing aromatic compound (B) is preferably 100 to 500, more preferably 120 to 450, and further preferably 135 to 400, from the standpoint of facilitating the effects of the present invention.

### <Additives>

The quench oils composition of one embodiment of the present invention is basically prepared by blending the component (A) and the component (B), and an additive having been commonly used in quench oils compositions may be blended depending on desire. Examples of the additive include one or more kind selected from a vapor blanket collapse agent, a brightness improver, an antioxidant, and a detergent dispersant. Preferred examples of the additive include one or more kind selected from a vapor blanket collapse agent, a brightness improver, and an antioxidant. More preferred examples of the additive include one or more kind selected from a vapor blanket collapse agent and a brightness improver. The component (B) has an antioxidation capability and the antioxidation capability of the quench oils composition can be retained with no antioxidant contained.

Accordingly the quench oils composition of one embodiment of the present invention may be a quench oils composition containing one or more kind selected from a vapor blanket collapse agent, a brightness improver, an antioxidant, and a detergent dispersant, in addition to the component (A) and the component (B), and may be a quench oils composition containing the component (A), the component (B), and one or more kind of an additive selected from a vapor blanket collapse agent, a brightness improver, an antioxidant, and a detergent dispersant.

The quench oils composition of one embodiment of the present invention may be a quench oils composition containing the component (A), the component (B), and one or more kind of an additive selected from a vapor blanket collapse agent, a brightness improver, and an antioxidant.

The quench oils composition of one embodiment of the present invention may be a quench oils composition containing the component (A), the component (B), and one or more kind of an additive selected from a vapor blanket collapse agent and a brightness improver. The component (B) has an antioxidation capability and the antioxidation capability of the quench oils composition can be retained with no antioxidant contained.

### (Vapor Blanket Collapse Agent)

Examples of the vapor blanket collapse agent include an ethylene-Ca-olefin copolymer (wherein the α-olefin has 3 to 20 carbon atoms), such as an ethylene-propylene copolymer; a hydrogenated product of the ethylene-Ca-olefin copolymer; a polymer of an α-olefin having 5 to 20 carbon atoms, such as 1-hexene, 1-octene, 1-decene, 1-dodecene, 1-tetradecene, 1-hexadecene, and 1-octadecene; a hydrogenated product of the polymer of an α-olefin; a polymer of an olefin having 3 or 4 carbon atoms, such as polypropylene, polybutene, and polyisobutylene; a hydrogenated product of the polymer of the olefin; a polymer compound, such as a polymethacrylate, a polymethacrylate, a polystyrene, and a petroleum resin; and asphalt.

The vapor blanket collapse agent may be used alone or as a combination of two or more kinds thereof.

The number average molecular weight (Mn) of the vapor blanket collapse agent is generally preferably 800 to 100,000. The number average molecular weight (Mn) of the vapor blanket collapse agent is a value that is measured by gel permeation chromatography (GPC) in terms of polystyrene.

The content of the vapor blanket collapse agent is preferably 0.5% by mass to 18% by mass, more preferably 1.0% by mass to 16% by mass, and further preferably 2.0% by mass to 15% by mass, based on the total amount of the quench oils composition.

### (Brightness Improver)

Examples of the brightness improver include fat and oil; a fat and oil fatty acid; an alkylsuccinic acid, such as an alkylsuccinimide; an alkenylsuccinic acid, such as an alkenylsuccinimide; and a substituted hydroxy aromatic carboxylate ester derivative.

The brightness improver may be used alone or as a combination of two or more kinds thereof.

The content of the brightness improver is preferably 0.1% by mass to 5.0% by mass, more preferably 0.3% by mass to 3.0% by mass, further preferably 0.4% by mass to 2.0% by mass, based on the total amount of the quench oils composition.

### (Antioxidant)

Examples of the antioxidant include a phenol-based antioxidant and an amine-based antioxidant.

Examples of the phenol-based antioxidant include a monocyclic phenol compound, such as 2,6-di-tert-butyl-4-methylphenol, 2,6-di-tert-butyl-4-ethylphenol, 2,4,6-tri-tert-butylphenol, 2,6-di-tert-butyl-4-hydroxymethylphenol, 2,6-di-tert-butylphenol, 2,4-dimethyl-6-tert-butylphenol, 2,6-di-tert-butyl-4-(N,N-dimethylaminomethyl)phenol, 2,6-di-tert-amyl-4-methylphenol, and n-octadecyl-3-(4-hydroxy-3,5-di-tert-butylphenyl) propionate; and a polycyclic phenol compound, such as 4,4′-methylenebis(2,6-di-tert-butylphenol), 4,4′-isopropylidenebis(2,6-di-tert-butylphenol), 2,2′-methylenebis(4-methyl-6-tert-butylphenol), 4,4′-bis(2,6-di-tert-butylphenol), 4,4?-bis(2-methyl-6-tert-butylphenol), 2,2′-methylenebis(4-ethyl-6-tert-butylphenol), 4,4′-butylidenebis(3-methyl-6-tert-butylphenol), 2,2′-thiobis(4-methyl-6-tert-butylphenol), and 4,4′-thiobis(3-methyl-6-tert-butylphenol).

Examples of the amine-based antioxidant include a diphenylamine-based antioxidant and a naphthylamine-based antioxidant.

Examples of the diphenylamine-based antioxidant include an alkylated diphenylamine having an alkyl group having 3 to 20 carbon atoms, and specific examples thereof include diphenylamine, monooctyldiphenylamine, monononyldiphenylamine, 4,4′-dibutyldiphenylamine, 4,4′-dihexyldiphenylamine, 4,4′-dioctyldiphenylamine, 4,4′-dinonyldiphenylamine, tetrabutyldiphenylamine, tetrahexyldiphenylamine, tetraoctyldiphenylamine, and tetranonyldiphenylamine.

Examples of the naphthylamine-based antioxidant include a phenyl-α-naphthylamine substituted by an alkyl group having 3 to 20 carbon atoms, and specific examples thereof include α-naphthylamine, phenyl-α-naphthylamine, butylphenyl-α-naphthylamine, hexylphenyl-α-naphthylamine, octylphenyl-α-naphthylamine, and nonylphenyl-α-naphthylamine.

The antioxidant may be used alone or as a combination of two or more kinds thereof.

The content of the antioxidant is preferably 0.01% by mass to 5.0% by mass, more preferably 0.05% by mass to 3.0% by mass, and further preferably 0.1% by mass to 2.0% by mass, based on the total amount of the quench oils composition.

### (Detergent Dispersant)

The detergent dispersant used may be one or more kind selected from the group consisting of a metal-based detergent and an ashless dispersant.

Examples of the metal-based detergent include a metal sulfonate, a metal salicylate, and a metal phenate.

Examples of the metal constituting the metal-based detergent include an alkali metal, such as sodium and calcium, and an alkaline earth metal, such as magnesium, calcium, and barium.

Examples of the ashless dispersant include an alkenylsuccinimide compound, a boron-containing alkenylsuccinimide compound, a benzylamine compound, a boron-containing benzylamine compound, a succinate ester compound, and a monovalent or divalent carboxylic amide represented by a fatty acid or succinic acid.

The detergent dispersant may be used alone or as a combination of two or more kinds thereof.

The content of the detergent dispersant may be 0.01% by mass to 5.0% by mass based on the total amount of the quench oils composition.

(Sulfide Compound Other than Sulfide Compound (B1) and Sulfone Compound Other than Sulfone Compound (B2))

The quench oils composition of one embodiment of the present invention may contain an additional sulfide compound other than the sulfide compound (B1), and the content of the additional sulfide compound is preferably small from the standpoint of improving the brightness of a metal material after a heat treatment, such as quenching.

In the quench oils composition of one embodiment of the present invention, the content of the additional sulfide compound is preferably less than 0.2% by mass, more preferably less than 0.1% by mass, further preferably less than 0.01% by mass, and still further preferably less than 0.001% by mass, based on the total amount of the quench oils composition, and it is still more further preferred that the additional sulfide compound is not contained.

Examples of the additional sulfide compound include a compound represented by the general formula (b1), wherein one or both of R¹¹ and R¹² are an aliphatic hydrocarbon group, and p=0.

The quench oils composition of one embodiment of the present invention may contain an additional sulfone compound other than the sulfone compound (B2), and the content of the additional sulfone compound is preferably small from the standpoint of improving the brightness of a metal material after a heat treatment, such as quenching.

In the quench oils composition of one embodiment of the present invention, the content of the additional sulfone compound is preferably less than 0.2% by mass, more preferably less than 0.1% by mass, further preferably less than 0.01% by mass, and still further preferably less than 0.001% by mass, based on the total amount of the quench oils composition, and it is still more further preferred that the additional sulfone compound is not contained.

Examples of the additional sulfone compound include a compound represented by the general formula (b2), wherein one or both of R²¹ and R²² are an aliphatic hydrocarbon group.

[Property Values of Quench oils Composition of Present Invention]<Sulfur Content>

The sulfur content of the quench oils composition of one embodiment of the present invention is preferably 10 ppm by mass or more, more preferably 100 ppm by mass or more, and further preferably 300 ppm by mass or more, and is preferably 15,000 ppm by mass or less, more preferably 12,000 ppm by mass or less, and further preferably 10,000 ppm by mass or less, based on the total amount of the quench oils composition.

The upper limit values and the lower limit values of these numerical ranges may be optionally combined. Specifically, the content thereof is preferably 10 ppm by mass to 15,000 ppm by mass, more preferably 100 ppm by mass to 12,000 ppm by mass, and further preferably 300 ppm by mass to 10,000 ppm by mass.

### <40° C. Kinematic Viscosity>

The 40° C. kinematic viscosity of the quench oils composition of one embodiment of the present invention is set corresponding to the target oil temperature in a heat treatment, such as quenching.

A quench oils composition is classified into a cold oil used at a low oil temperature, a hot oil used at a high oil temperature, and a semi-hot oil used at an oil temperature therebetween. The cold oil is classified into Type 1 of JIS K2242:2012, and the semi-hot oil and the hot oil are classified into Type 2 of JIS K2242:2012.

In the case where the quench oils composition of one embodiment of the present invention is used as a cold oil, the 40° C. kinematic viscosity thereof is preferably 5 mm²/s or more and less than 40 mm²/s.

In the case where the quench oils composition of one embodiment of the present invention is used as a hot oil or a semi-hot oil, the 40° C. kinematic viscosity thereof is more preferably 40 mm²/s or more and 500 mm²/s or less.

[Method for producing Quench oils Composition of Present Invention]

The method for producing the quench oils composition of the present invention is not particularly limited.

For example, a method for producing a quench oils composition of one embodiment of the present invention may include a step of mixing one or more kind of a base oil (A) selected from the group consisting of a mineral oil (A1), a synthetic oil (A2), and a vegetable oil (A3), and one or more kind of a sulfur-containing aromatic compound (B) selected from the group consisting of a sulfide compound (B1) represented by the following general formula (b1) and a sulfone compound (B2) represented by the following general formula (b2):

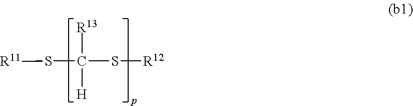

wherein in the general formula (b1), R¹¹, R¹², and R¹³ each independently represent a substituted or unsubstituted aryl group having 6 to 10 carbon atoms, and p represents 0 or 1,

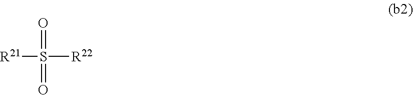

wherein in the general formula (b2), R²¹ and R²² each independently represent a substituted or unsubstituted aryl group having 6 to 10 carbon atoms.

The method of mixing the components is not particularly limited, and examples thereof include a step of blending the sulfur-containing aromatic compound (B) with the base oil (A). In the case where the quench oils composition further contains an additional component other than the base oil (A) and the sulfur-containing aromatic compound (B), the additional component may be blended simultaneously with the sulfur-containing aromatic compound (B) with the base oil (A), and may be blended separately therefrom. The components each may be blended in the form of a solution (dispersion) by adding a diluent oil or the like. After blending the components, the components are preferably agitated by a known method for dispersing uniformly.

The preferred embodiments of the base oil (A) and the sulfur-containing aromatic compound (B) have been described above.

[Applications of Quench oils Composition of Present Invention]

The quench oils composition of the present invention can be used in a heat treatment, such as quenching, of a metal material, and thereby the brightness of the metal material after the heat treatment, such as quenching, can be improved. For example, the quench oils composition can be favorably used as a quench oils composition in performing a heat treatment, such as quenching, of various alloy steels, such as a carbon steel, a nickel-manganese steel, a chromium-molybdenum steel, and a manganese steel.

Accordingly the present invention also provides a heat treatment method of a metal material, including using the quench oils composition of the present invention in a heat treatment, such as quenching, of a metal material. In this case, the oil temperature of the quench oils composition in the case where the heat treatment is quenching is preferably set to 60° C. to 200° C., and more preferably 60° C. to 150° C. In the case where the heat treatment is tempering, the oil temperature may be further increased, and the upper limit thereof may be, for example, 250° C. The heating temperature of a metal material may be 800° C. or more and 900° C. or less, and may be more than 900° C. and 1,000° C. or less. The quench oils composition of the present invention can improve the brightness of the metal material after quenching even in the case where the heating temperature of the metal material is more than 900° C. and 1,000° C. or less.

### Embodiments Provided by Present Invention

The present invention provides embodiments of the following items [1] to [12].

[1] a Quench Oils Composition Containing

one or more kind of a base oil (A) selected from the group consisting of a mineral oil (A1), a synthetic oil (A2), and a vegetable oil (A3), and

one or more kind of a sulfur-containing aromatic compound (B) selected from the group consisting of a sulfide compound (B1) represented by the following general formula (b1) and a sulfone compound (B2) represented by the following general formula (b2):

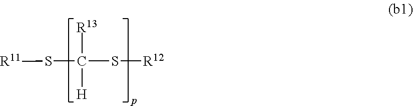

wherein in the general formula (b1), R¹¹, R¹², and R¹³ each independently represent a substituted or unsubstituted aryl group having 6 to 10 carbon atoms, and p represents 0 or 1,

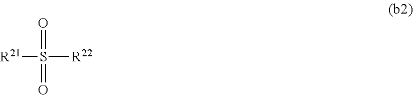

wherein in the general formula (b2), R²¹ and R²² each independently represent a substituted or unsubstituted aryl group having 6 to 10 carbon atoms.

[2] The quench oils composition according to the item [1], wherein in the general formula (b1), R¹¹ represents a substituted or unsubstituted phenyl group.

[3] The quench oils composition according to the item [1] or [2], wherein in the general formula (b1), R¹² represents a substituted or unsubstituted phenyl group.

[4] The quench oils composition according to any one of the items [1] to [3], wherein in the general formula (b1), R¹³ represents a substituted or unsubstituted phenyl group.

[5] The quench oils composition according to any one of the items [1] to [3], wherein in the general formula (b1), p is 0.

[6] The quench oils composition according to any one of the items [1] to [5], wherein in the general formula (b2), R²¹ represents a substituted or unsubstituted phenyl group.

[7] The quench oils composition according to any one of the items [1] to [6], wherein in the general formula (b2), R²² represents a substituted or unsubstituted phenyl group.

[8] The quench oils composition according to any one of the items [1] to [7], wherein the sulfur-containing aromatic compound (B) has a molecular weight of 100 to 500.

[9] The quench oils composition according to any one of the items [1] to [8], wherein the quench oils composition has a sulfur content of 10 ppm by mass to 15,000 ppm by mass based on the total amount of the quench oils composition.

[10] The quench oils composition according to any one of the items [1] to [9], wherein the quench oils composition has a content of the sulfur-containing aromatic compound (B) of 0.02% by mass to 5.5% by mass based on the total amount of the quench oils composition.

[11] The quench oils composition according to any one of the items [1] to [10], wherein the quench oils composition further contains one or more kind of an additive selected from the group consisting of a vapor blanket collapse agent, a brightness improver, an antioxidant, and a detergent dispersant.

[12] A method for producing a quench oils composition, including a step of mixing

one or more kind of a base oil (A) selected from the group consisting of a mineral oil (A1), a synthetic oil (A2), and a vegetable oil (A3), and

one or more kind of a sulfur-containing aromatic compound (B) selected from the group consisting of a sulfide compound (B1) represented by the following general formula (b1) and a sulfone compound (B2) represented by the following general formula (b2):

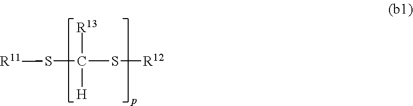

wherein in the general formula (b1). R¹¹. R¹². and R¹³ each independently represent a substituted or unsubstituted aryl group having 6 to 10 carbon atoms, and p represents 0 or 1,

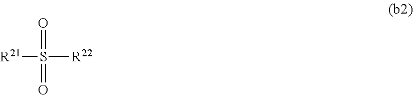

wherein in the general formula (b2), R²¹ and R²² each independently represent a substituted or unsubstituted aryl group having 6 to 10 carbon atoms.

### EXAMPLES

The present invention will be described more specifically with reference to examples below, but the present invention is not limited to the following examples.

### [Measurement Method of Property Values]

(1) 40° C. Kinematic Viscosity of Base Oil (A) and Quench oils Composition

The base oils (A) used in Examples and Comparative Examples and the quench oils compositions prepared in Examples and Comparative Examples were measured for the 40° C. kinematic viscosity according to JIS K2283:2000.

(2) Sulfur Content

The base oils (A) used in Examples and Comparative Examples and the quench oils compositions prepared in Examples and Comparative Examples were measured for the sulfur content according to the ultraviolet fluorescent method of JIS K2541-6:2013 for the measurement of ppm by mass order amounts, or according to the wavelength dispersive X-ray spectroscopy of JIS K2541-7:2013 for the measurement of % by mass order amounts.

### Examples 1 to 10 and Comparative Examples 1 to 5

The raw materials used for preparing the quench oils compositions of Examples 1 to 10 and Comparative Examples 1 to 5 are shown below.

(1) Base Oil (A)

### Mineral Oil (A1)-1:

Mineral oil classified into Group III of API Category sulfur content: less than 3 ppm by mass, 40° C. kinematic viscosity: 12.53 mm²/s

### Mineral Oil (A1)-2:

Mineral oil classified into Group III of API Category, sulfur content: less than 3 ppm by mass, 40° C. kinematic viscosity: 41.81 mm²/s Mineral oil (A1)-3:

High viscosity mineral oil classified into Group II of API Category, sulfur content: less than 3 ppm by mass, 40° C. kinematic viscosity: 396.7 mm²/s Mineral oil (A1)-4:

High viscosity mineral oil classified into Group I of API Category (corresponding to bright stock (A1-2)), sulfur content: 1.12% by mass, 40° C. kinematic viscosity: 481.8 mm²/s Synthetic oil (A2)-1:

GTL base oil classified into Group III of API Category, sulfur content: less than 3 ppm by mass, 40° C. kinematic viscosity: 9.640 mm²/s

(2) Sulfur-containing Aromatic Compound (B) Sulfide compound (B1)-1:

Diphenyl sulfide (molecular weight: 186.27)

Compound represented by the following chemical formula (b1-1)

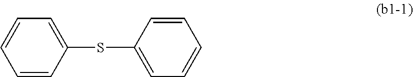 [SMILES: c1ccc(Sc2ccccc2)cc1]

The compound represented by the chemical formula (b1-1) corresponds to the compound represented by the general formula (b1), wherein R¹¹ and R¹² represent unsubstituted phenyl groups (i.e., in the general formula (b·x), m=0), and p is 0.

### Sulfide Compound (B1)-2:

Phenylbis(phenylthio)methane (molecular weight: 308.46)

Compound represented by the following chemical formula (b1-2)

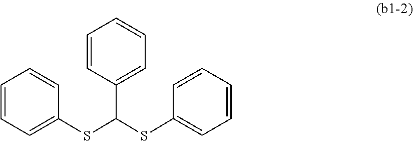 [SMILES: c1ccc(SC(Sc2ccccc2)c2ccccc2)cc1]

The compound represented by the chemical formula (b1-2) corresponds to the compound represented by the general formula (b1), wherein R¹¹, R¹², and R¹³ represent unsubstituted phenyl groups (i.e., in the general formula (b·x), m=0), and p is 1.

### Sulfide Compound (B1)-3:

4,4′-Thiobis(6-tert-butyl-m-cresol) (molecular weight: 358.54) Compound represented by the following chemical formula (b1-3)

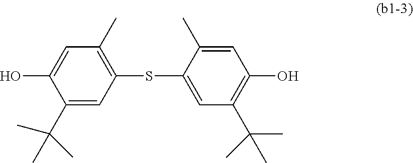 [SMILES: Cc1cc(O)c(C(C)(C)C)cc1Sc1cc(C(C)(C)C)c(O)cc1C]

The compound represented by the chemical formula (b1-3) corresponds to the compound represented by the general formula (b1), wherein R¹¹ and R¹² represent 6-tert-butyl-m-cresyl groups (i.e., in the general formula (b·x), m=3, three groups represented by R^{X}1 represent a methyl group, a tert-butyl group, and a hydroxy group, respectively and the substitution position of the hydroxy group is the para-position with respect to the sulfur atom), and p is 0.

### Sulfide Compound (B1)-4:

4-tert-Butyldiphenyl sulfide (molecular weight: 242.38)

Compound represented by the following chemical formula (b1-4)

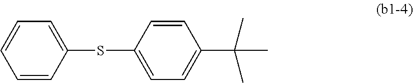 [SMILES: CC(C)(C)c1ccc(Sc2ccccc2)cc1]

The compound represented by the chemical formula (b1-4) corresponds to the compound represented by the general formula (b1), wherein R¹¹ represents an unsubstituted phenyl group (i.e., in the general formula (b·x), m=0), R¹² represents a tert-butylphenyl group (i.e., in the general formula (b·x), m=1, R^{X}1 represents a tert-butyl group, and the substitution position of the tert-butyl group is the para-position with respect to the sulfur atom), and p is 0.

Sulfone compound (B2)-1:

Diphenyl sulfone (molecular weight: 218.27)

Compound represented by the following chemical formula (b2-1)

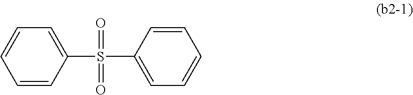 [SMILES: O=S(=O)(c1ccccc1)c1ccccc1]

The compound represented by the chemical formula (b2-1) corresponds to the compound represented by the general formula (b2), wherein R²¹ and R²² represent unsubstituted phenyl groups (i.e., in the general formula (b·x), m=0).

(2′) Sulfur-containing Non-aromatic Compound (B′)

Didodecyl sulfide (molecular weight: 370.72)

Compound represented by the following chemical formula (b′)

C₁₂H₂₅—S—C₁₂H₂₅ (b′)

The compound represented by the chemical formula (b′) is a compound that does not correspond to any of the general formulae (b1) and (b2).

(3) Additives

Vapor blanket collapse agent, brightness improver, and antioxidant (phenol-based antioxidant)

The raw materials were sufficiently mixed in the blending amounts (% by mass) shown in Tables 1 to 5, so as to prepare the quench oils compositions of Examples 1 to 10 and Comparative Examples 1 to 5.

### <Evaluation Method of Brightness>

The brightness of the steel material after quenching was evaluated with reference to “Influence of Oxygen in Quench oils Tank on Brightness (Idemitsu Tribo Review, No. 31, pp. 1963-1966, published on September 30, Heisei 20 (2008)).

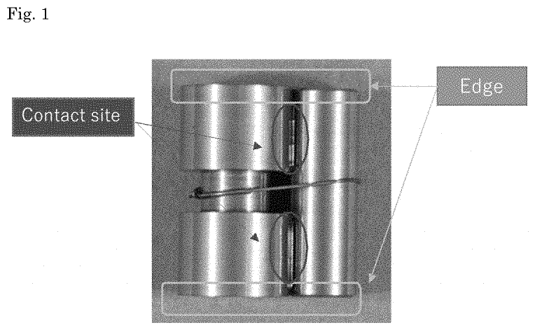

Specifically a dumbbell specimen of S45C Steel (diameter: 16 mm, length: 30 mm, hardness H_{RC}: 16) and a cylindrical specimen of SUJ2 Steel (diameter: 10 mm, length: 30 mm, hardness H_{RC}: 15) were combined to prepare a test piece. In more detail, the dumbbell specimen of S45C Steel and the cylindrical specimen of SUJ2 Steel were banded by tying with a SUS 303 wire at the center (see FIG. 1). A quenching test was performed in such a manner that the test piece was heated in a furnace having a mixed gas atmosphere of nitrogen and hydrogen, and then the test piece was quenched by placing in a quench oils composition.

The conditions of the quenching test were the following four conditions.

### (Quenching Test Condition 1: Cold Oil Assumed Test 1, Tables 1 to 3)

Test object: Comparative Examples 1 and 2 and Examples 1 to 8

Furnace temperature: 850° C.

Test piece retention time in furnace: 40 minutes after furnace temperature reached 850° C.

Temperature of quench oils composition: 80° C.

Immersion time of test piece in quench oils composition (quenching time): 10 minutes

### (Quenching Test Condition 2: Hot Oil Assumed Test, Table 4)

Test object: Comparative Examples 3 and 4 and Example 9

Furnace temperature: 850° C.

Test piece retention time in furnace: 40 minutes after furnace temperature reached 850° C.

Temperature of quench oils composition: 120° C.

Immersion time of test piece in quench oils composition (quenching time): 10 minutes

### (Quenching Test Condition 3: Cold Oil Assumed Test 2, Table 5)

Test object: Comparative Example 5 and Example 10

Furnace temperature: 975° C.

Test piece retention time in furnace: 40 minutes after furnace temperature reached 975° C.

Temperature of quench oils composition: 60° C.

Immersion time of test piece in quench oils composition (quenching time): 10 minutes

The test piece after quenching was evaluated for brightness focusing on the “brightness”, the “coloration at edge”, and the “coloration at contact site” based on the following standard. The brightness of the test piece was comprehensively evaluated by the following standard based on the evaluation results of the “brightness”, the “coloration at edge”, and the “coloration at contact site”.

### (Brightness)

An appearance sample having been colored as prescribed was produced, and the color of the quenched test piece was evaluated by visually comparing therewith. The extent of coloration of the appearance sample is shown by the following numerals.

0: No coloration

1: Pale coloration

2: Blackish brown to black coloration

(Coloration at Edge) The edge of the test piece (see FIG. 1) was visually observed and evaluated by the following standard.

0: No or substantially no coloration

1: Pale coloration

2: Blackish brown to black coloration

### (Coloration at Contact Site)

The test piece (at the contact site of the dumbbell steel specimen and the cylindrical steel specimen, see FIG. 1) was visually observed and evaluated by the following standard.

0: No or substantially no coloration

1: Pale coloration

2: Blackish brown to black coloration

### (Comprehensive Evaluation of Brightness)

The comprehensive evaluation was performed by using the evaluation results of the “brightness”, the “coloration at edge”, and the “coloration at contact site” based on the following standard.

Evaluation S: The sum of the evaluation results of the “brightness”, the “coloration at edge”, and the “coloration at contact site” was 0.

Evaluation A: The sum of the evaluation results of the “brightness”, the “coloration at edge”, and the “coloration at contact site” was 1.

Evaluation B: The sum of the evaluation results of the “brightness”, the “coloration at edge”, and the “coloration at contact site” was 2.

Evaluation C: The sum of the evaluation results of the “brightness”, the “coloration at edge”, and the “coloration at contact site” was 3 or more.

In the case where the evaluation result of any one of the “brightness”, the “coloration at edge”, and the “coloration at contact site” was 2 or more, the evaluation was designated as C.

The quench oils composition of the evaluation S is significantly excellent in brightness. The quench oils composition of the evaluation A is excellent in brightness. The quench oils composition of the evaluation B is slightly inferior in brightness. The quench oils composition of the evaluation C is inferior in brightness.

The results are shown in Tables 1 to 5. In Tables 1 to 5, “>” means “less than”.

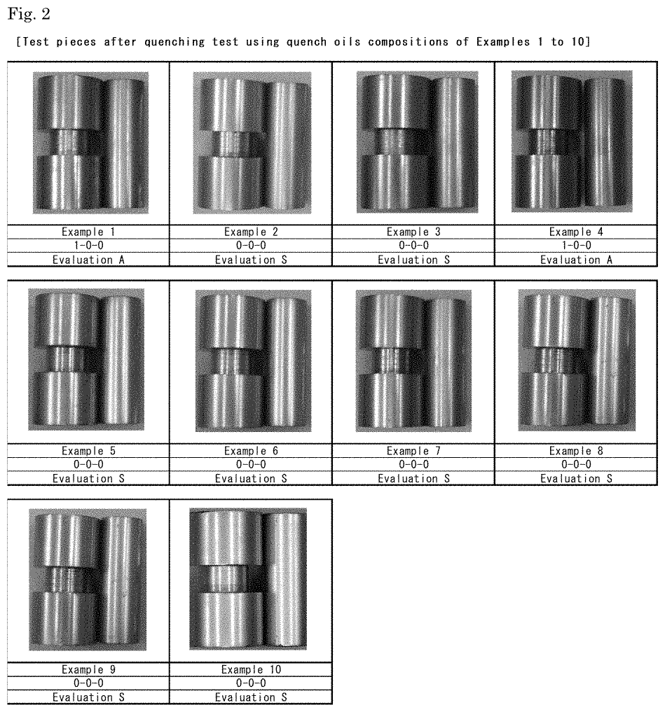

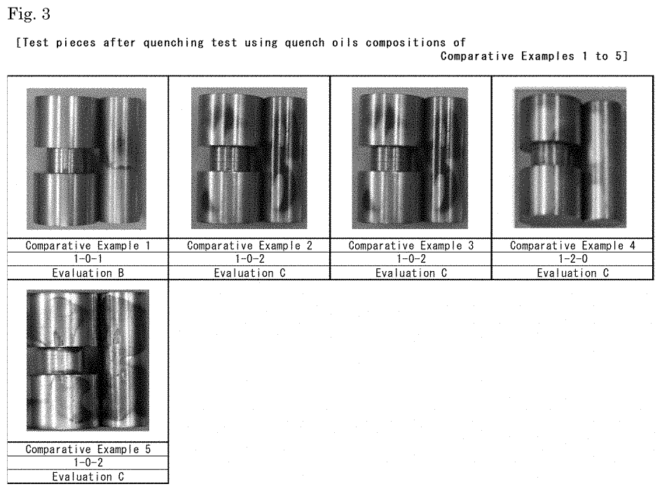

FIG. 2 shows the test pieces after the quenching test using the quench oils compositions of Examples 1 to 10, and FIG. 3 shows the test pieces after the quenching test using the quench oils compositions of Comparative Examples 1 to 5.

TABLE 1

| | | | | | Comparative | Example | Example | Example |
|---|---|---|---|---|---|---|---|---|
| | | | | Unit | Example 1 | 1 | 2 | 3 |
| Composition of | Base oil (A) | Mineral oil (A1)-1 | | % by mass | 95.50 | 95.48 | 95.30 | 91.50 |
| quench oils | Sulfur-containing | Sulfide | Diphenyl | % by mass | — | 0.02 | 0.20 | 4.00 |
| composition | aromatic compound (B) | compound (B1)-1 | sulfide | | | | | |

| | | | | | | |
|---|---|---|---|---|---|---|
| Additive | Vapor blanket collapse agent | % by mass | 3.00 | 3.00 | 3.00 | 3.00 |
| | Brightness improver | % by mass | 1.50 | 1.50 | 1.50 | 1.50 |

| | | | | | |
|---|---|---|---|---|---|
| Total | % by mass | 100.00 | 100.00 | 100.00 | 100.00 |

| | | | | | | |
|---|---|---|---|---|---|---|
| Property values of quench | Sulfur content | ppm by mass | 3> | 17 | 339 | 6,600 |
| oils composition | 40° C. Kinematic | mm²/s | 16.13 | 16.13 | 16.04 | 14.31 |
| | viscosity | | | | | |

| | | | | | | |
|---|---|---|---|---|---|---|
| Evaluation | (Brightness)-(Coloration at edge)- | — | 1-0-1 | 1-0-0 | 0-0-0 | 0-0-0 |
| result of | (Coloration at contact site) | | | | | |
| brightness | Comprehensive evaluation | — | B | A | S | S |

TABLE 2

| | | | | | Comparative | Example | Example | Example | Example | Example |
|---|---|---|---|---|---|---|---|---|---|---|
| | | | | Unit | Example 1 | 2 | 4 | 5 | 6 | 7 |
| Composition of | Base oil (A) | Mineral oil (A1)-1 | | % by mass | 95.50 | 95.30 | 95.30 | 95.30 | 95.30 | 95.30 |
| quench oils | Sulfur- | Sulfide | Diphenyl | % by mass | — | 0.20 | — | — | — | — |
| composition | containing | compound | sulfide | | | | | | | |
| | aromatic | (B1)-1 | | | | | | | | |
| | compound | Sulfide | Phenyl- | % by mass | — | — | 0.20 | — | — | — |
| | (B) | compound | bis(phenyl- | | | | | | | |
| | | (B1)-2 | thio)-methane | | | | | | | |
| | | Sulfide | 4,4′- | % by mass | — | — | — | 0.20 | — | — |
| | | compound | Thiobis(6- | | | | | | | |
| | | (B1)-3 | tert-butyl- | | | | | | | |
| | | | m-cresol) | | | | | | | |
| | | Sulfide | 4-tert-Butyl- | % by mass | — | — | — | — | 0.20 | — |
| | | compound | diphsnyl | | | | | | | |
| | | (B1)-4 | sulfide | | | | | | | |
| | | Sulfone | Diphenyl | % by mass | — | — | — | — | — | 0.20 |
| | | compound | sulfone | | | | | | | |
| | | (B2)-1 | | | | | | | | |

| | | | | | | | | |
|---|---|---|---|---|---|---|---|---|
| Additive | Vapor blanket collapse agent | % by mass | 3.00 | 3.00 | 3.00 | 3.00 | 3.00 | 3.00 |
| | Brightness improver | % by mass | 1.50 | 1.50 | 1.50 | 1.50 | 1.50 | 1.50 |

| | | | | | | | |
|---|---|---|---|---|---|---|---|
| Total | % by mass | 100.00 | 100.00 | 100.00 | 100.00 | 100.00 | 100.00 |

| | | | | | | | | |
|---|---|---|---|---|---|---|---|---|
| Property values of quench | Sulfur content | ppm by mass | 3> | 339 | 406 | 269 | 161 | 278 |
| oils composition | 40° C. | mm²/s | 16.13 | 16.04 | 16.12 | 16.09 | 16.18 | 16.11 |
| | Kinematic | | | | | | | |
| | viscosity | | | | | | | |

| | | | | | | | | |
|---|---|---|---|---|---|---|---|---|
| Evaluation | (Brightness)-(Coloration at edge)- | — | 1-0-1 | 0-0-0 | 1-0-0 | 0-0-0 | 0-0-0 | 0-0-0 |
| result of | (Coloration at contact site) | | | | | | | |
| brightness | Comprehensive evaluation | — | B | S | A | S | S | S |

TABLE 3

| | | | | | Comparative | Example |
|---|---|---|---|---|---|---|
| | | | | Unit | Example 2 | 8 |
| Composition of | Base oil (A) | Synthetic oil (A2)-1 | | % by mass | 41.50 | 41.30 |
| quench oils | | Mineral oil (A1)-2 | | % by mass | 50.00 | 50.00 |
| composition | Sulfur containing | Sulfide | Diphenyl | % by mass | — | 0.20 |
| | aromatic compound (B) | compound (B1)-1 | sulfide | | | |

| | | | | |
|---|---|---|---|---|
| Additive | Vapor blanket collapse agent | % by mass | 7.00 | 7.00 |
| | Brightness improver | % by mass | 1.50 | 1.50 |

| | | | |
|---|---|---|---|
| Total | % by mass | 100.00 | 100.00 |

| | | | | |
|---|---|---|---|---|
| Property values of quench | Sulfur content | ppm by mass | 3> | 343 |
| oils composition | 40° C. Kinematic | mm²/s | 27.38 | 27.17 |
| | viscosity | | | |

| | | | | |
|---|---|---|---|---|
| Evaluation | (Brightness)-(Coloration at edge)- | — | 1-0-2 | 0-0-0 |
| result of | (Coloration at contact site) | | | |
| brightness | Comprehensive evaluation | — | C | S |

TABLE 4

| | | | | | Comparative | Comparative | Example |
|---|---|---|---|---|---|---|---|
| | | | | Unit | Example 3 | Example 4 | 9 |
| Composition of | Base oil (A) | Mineral oil (A-1)-3 | | % by mass | 100.00 | 99.80 | 99.90 |
| quench oils | Sulfur-containing | Sulfide | Diphenyl | % by mass | — | — | 0.10 |
| composition | aromatic compound (B) | compound (B1)-1 | sulfide | | | | |

| | | | | | |
|---|---|---|---|---|---|
| Sulfur-containing | Didodecyl sulfide | % by mass | — | 0.20 | — |
| non-aromatic | | | | | |
| compound (B′) | | | | | |

| | | | | |
|---|---|---|---|---|
| Total | % by mass | 100.00 | 100.00 | 100.00 |

| | | | | | |
|---|---|---|---|---|---|
| Property values of quench | Sulfur content | ppm by mass | 3> | 172 | 170 |
| oils composition | 40° C. Kinematic | mm²/s | 396.7 | 396.4 | 396.5 |
| | viscosity | | | | |

| | | | | | |
|---|---|---|---|---|---|
| Evaluation | (Brightness)-(Coloration at edge)- | — | 1-0-2 | 1-2-0 | 0-0-0 |
| result of | (Coloration at contact site) | | | | |
| brightness | Comprehensive evaluation | — | C | C | S |

TABLE 5

| | | | | | Comparative | Example |
|---|---|---|---|---|---|---|
| | | | | Unit | Example 5 | 10 |
| Composition of | Base oil (A) | Mineral oil (A1)-1 | | % by mass | 88.30 | 88.20 |
| quench oils | | Mineral oil (A1)-4 | | % by mass | 7.00 | 7.00 |
| composition | Sulfur-containing | Sulfide | Diphenyl | % by mass | — | 0.10 |
| | aromatic compound (B) | compound (B1)-1 | sulfide | | | |

| | | | | |
|---|---|---|---|---|
| Additive | Vapor blanket collapse agent | % by mass | 3.00 | 3.00 |
| | Brightness improver | % by mass | 1.50 | 1.50 |

| | | | | |
|---|---|---|---|---|
| Antioxidant | Phenolbased | % by mass | 0.20 | 0.20 |
| | antioxidant | | | |

| | | | |
|---|---|---|---|
| Total | % by mass | 100.00 | 100.00 |

| | | | | |
|---|---|---|---|---|
| Property values of quench | Sulfur content | % by mass | 0.08 | 0.09 |
| oils composition | 40° C. Kinematic | mm²/s | 18.88 | 18.85 |
| | viscosity | | | |

| | | | | |
|---|---|---|---|---|
| Evaluation | (Brightness)-(Coloration at edge)- | — | 1-0-2 | 0-0-0 |
| result of | (Coloration at contact site) | | | |
| brightness | Comprehensive evaluation | — | C | S |

The following matters are found from Tables 1 to 5.

It is understood that the quench oils compositions of Examples 1 to 10, which contain the sulfur-containing aromatic compound (B), can improve the brightness of the test piece after quenching.

On the other hand, it is understood that the quench oils compositions of Comparative Examples 1 to 5, which do not contain the sulfur-containing aromatic compound (B), lower the brightness of the test piece after quenching. It is also understood that the quench oils composition, which has blended therein a sulfide compound having a linear alkyl group bonded to the sulfur atom, but having no aromatic group bonded to the sulfur atom, such as the quench oils composition of Comparative Example 4, lowers the brightness of the test piece after quenching.

### <Investigation on Formation of Sludge>

The quench oils compositions of Example 5 and Comparative Example 1 were investigated on the formation of sludge.

Specifically the quench oils compositions of Example 5 and Comparative Example 1 were forcedly deteriorated, and the formation of sludge was investigated.

The forced deterioration method was in accordance with the Indiana oxidation test (IOT) method. The condition was as follows.

Oil temperature: 170° C.

Air flow rate: 10 L/min

Catalyst: Combination of iron (Fe) and copper (Cu)

Forced deterioration time: 48 hours or 96 hours

The deteriorated oil with a forced deterioration time of 48 hours and the deteriorated oil with a forced deterioration time of 96 hours were measured for the insoluble content and the residual carbon content for evaluating the sludge formation amount. Larger values of the insoluble content and the residual carbon content mean a larger sludge formation amount, whereas smaller values thereof mean a smaller sludge formation amount.

The insoluble content was measured according to ASTM D893-14 (2018).

The residual carbon content was measured according to JIS K2270-2:2009.

The results are shown in Table 6.

1. A quench oils composition, comprising:
at least one base oil (A) selected from the group consisting of a mineral oil (A1), a synthetic oil (A2), and a vegetable oil (A3); and
at least one sulfur-containing aromatic compound (B) selected from the group consisting of a sulfide compound (B1) represented by a formula (b 1) and a sulfone compound (B2) represented by formula (b2): 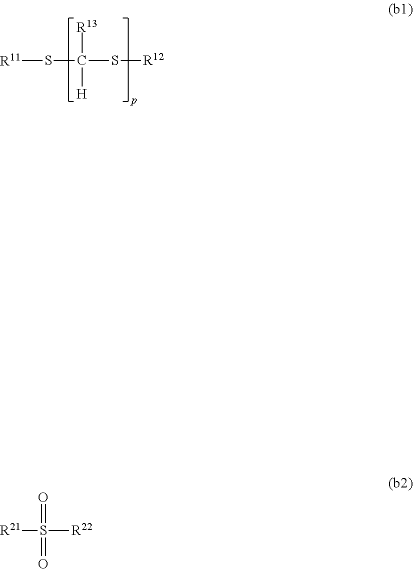
wherein
in the formula (b1), R¹¹, R¹², and R¹³ each independently represents a substituted or unsubstituted aryl group having 6 to 10 carbon atoms, and p represents 0 or 1, and
in the formula (b2), R²¹ and R²² each independently represents a substituted or unsubstituted aryl group having 6 to 10 carbon atoms.

2. The composition according to claim 1, wherein in the formula (b1), R¹¹ represents a substituted or unsubstituted phenyl group.

3. The composition according to claim 1, wherein in the formula (b1), R¹² represents a substituted or unsubstituted phenyl group.

4. The composition according to claim 1, wherein in the formula (b1), R¹³ represents a substituted or unsubstituted phenyl group.

5. The composition according to claim 1, wherein in the formula (b1), p is 0.

6. The composition according to claim 1, wherein in the formula (b2), R²¹ represents a substituted or unsubstituted phenyl group.

7. The composition according to claim 1, wherein in the formula (b2), R²² represents a substituted or unsubstituted phenyl group.

8. The composition according to claim 1, wherein the sulfur-containing aromatic compound (B) has a molecular weight of 100 to 500.

9. The composition according to claim 1, wherein a sulfur content of the composition is 10 ppm by mass to 15,000 ppm by mass based on the total amount of the composition.

10. The composition according to claim 1, wherein content of the sulfur-containing aromatic compound (B) is 0.02% by mass to 5.5% by mass based on the total amount of the composition.

11. The composition according to claim 1, comprising at least one additive selected from the group consisting of a vapor blanket collapse agent, a brightness improver, an antioxidant, and a detergent dispersant.

12. A method for producing a quench oils composition, comprising:
mixing at least one base oil (A) selected from the group consisting of a mineral oil (A1), a synthetic oil (A2), and a vegetable oil (A3), and
at least one sulfur-containing aromatic compound (B) selected from the group consisting of a sulfide compound (B1) represented by a formula (b 1) and a sulfone compound (B2) represented by a formula (b2): 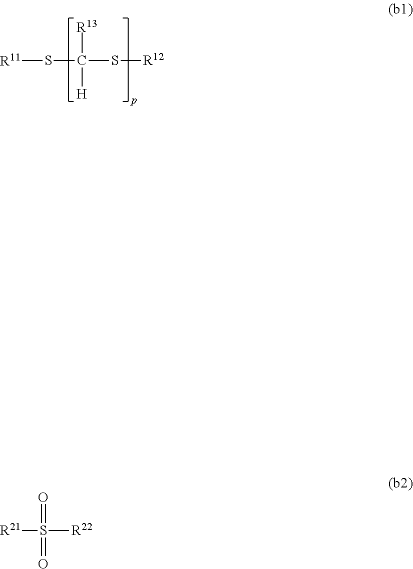
wherein
in the formula (b1), R¹¹, R¹², and R¹³ each independently represents a substituted or unsubstituted aryl group having 6 to 10 carbon atoms, and p represents 0 or 1, and
in the formula (b2), R²¹ and R²² each independently represents a substituted or unsubstituted aryl group having 6 to 10 carbon atoms.
